(19) United States
(12) Patent Application Publication
(10) Pub. No.: US 2020/0124200 A1
(43) Pub. Date: Apr. 23, 2020

(54) FLUID CONTROL VALVE

(71) Applicant: HAMANAKODENSO CO., LTD., Kosai-city (JP)

(72) Inventor: Hideya TOCHIHARA, Kosai-city (JP)

(21) Appl. No.: 16/600,607

(22) Filed: Oct. 14, 2019

(30) Foreign Application Priority Data
Oct. 22, 2018 (JP) 2018-198544

(51) Int. Cl. F16K 31/06; F01P 7/14

(52) U.S. Cl. CPC F16K 31/0651; F01P 2007/146; F01P 7/14

(57) ABSTRACT

A fluid control valve includes a housing having a fluid passage through which a liquid working fluid flows, and a valve element switched between a valve open state in which the valve element is positioned to open the fluid passage and a valve closed state in which the valve element is positioned to close the fluid passage. A plunger moves in an axial direction to drive the valve element, and a coil generates a magnetic force that moves the plunger in the axial direction. A relief valve mechanism allows the working fluid to flow through the fluid passage with keeping a position of the plunger in the axial direction when a fluid pressure of the working fluid exceeds a predetermined pressure in the valve closed state.

### CROSS REFERENCE TO RELATED APPLICATION

This application is based on and incorporates herein by reference Japanese Patent Application No. 2018-198544 filed on Oct. 22, 2018.

### TECHNICAL FIELD

The present disclosure relates to a fluid control valve.

### BACKGROUND

A fluid control valve is provided in an engine cooling circuit to permit and block flow of fluid that has flowed out of an engine.

### SUMMARY

According to an embodiment of the present disclosure, a fluid control valve includes a relief valve mechanism that allows working fluid to flow through a fluid passage with keeping a position of a plunger in an axial direction when a fluid pressure of the working fluid exceeds a predetermined pressure in a valve closed state,

### BRIEF DESCRIPTION OF THE DRAWINGS

FIG. 1 is a Brock diagram showing a cooling water circuit according to a first embodiment.

FIG. 2 is a cross-sectional view showing a valve open state of a fluid control valve according to the first embodiment.

FIG. 3 is a cross-sectional view showing a valve closed state of the fluid control valve according to the first embodiment.

FIG. 4 is a characteristic diagram showing a relationship between stroke position and suction force for a first path and a second path.

FIG. 5 is a perspective view showing a relief valve assembly of the fluid control valve in a state in which a fluid passage is closed, according to the first embodiment.

FIG. 6 is a side view showing the relief valve assembly of the fluid control valve in the state in which the fluid passage is closed, according to the first embodiment.

FIG. 7 is a cross-sectional view showing the fluid control valve in a state in which the fluid passage is opened by elastic deformation of a biasing member, according to the first embodiment.

FIG. 8 is a perspective view showing the relief valve assembly of the fluid control valve in a state in which the fluid passage is open, according to the first embodiment.

FIG. 9 is a side view showing the relief valve assembly of the fluid control valve in the state in which the fluid passage is open, according to the first embodiment.

FIG. 10 is a cross-sectional view showing a valve closed state of a fluid control valve according to a second embodiment.

FIG. 11 is a cross-sectional view showing the fluid control valve in a state in which a fluid passage is opened by an auxiliary valve, according to the second embodiment.

FIG. 12 is a cross-sectional view showing a valve closed state of a fluid control valve according to a third embodiment.

### DETAILED DESCRIPTION

A comparative example will be described below. A fluid control valve of the comparative example is provided in an engine cooling circuit to permit and block flow of fluid that has flowed out of an engine. When a fluid pressure of cooling water is not present, the fluid control valve is maintained in a closed state by a biasing force of a biasing spring and an attraction force attracting a plunger to a fixed core. When the fluid pressure of the cooling water exceeds the biasing force of the biasing spring, the plunger moves in a direction away from the fixed core by the fluid pressure and the fluid control valve opens.

The pressure in a pipe connected to the fluid control valve as in the comparative example may vary greatly depending on a volume of the pipe or an operating state of a drive source that drives the fluid for the engine. Therefore, the pressure resistance of the pipe may be increased in the circuit in which the pressure variation range in the pipe becomes large.

In contrast to the comparative example, the present disclosure provides a fluid control valve capable of reducing pressure resistance required for a pipe connected to the fluid control valve even when an excessive pressure is generated in a closed state of the fluid control valve.

According to an aspect of the present disclosure, a fluid control valve includes a housing, a valve element, a plunger, a coil and a relief valve mechanism. The housing has a fluid passage through which a liquid working fluid flows. The valve element is provided inside the housing and switched between a valve open state in which the valve element is positioned to open the fluid passage and a valve closed state in which the valve element is positioned to close the fluid passage. The plunger is provided inside the housing and moved in an axial direction to drive the valve element. The coil is provided inside the housing and generates a magnetic force that moves the plunger in the axial direction. The relief valve mechanism allows the working fluid to flow through the fluid passage without moving the plunger in the axial direction when a fluid pressure of the working fluid exceeds a predetermined pressure in the valve closed state.

According to the fluid control valve of the present disclosure, the relief valve mechanism operates to allow the working fluid to flow through the fluid passage while keeping a position of the plunger in the axial direction when the fluid pressure exceeds the predetermined pressure in the valve closed state. Since the fluid control valve includes the relief valve mechanism that operates in the above manner, even when a pressure in a pipe connected to the fluid control valve increases, the working fluid starts flowing through the fluid passage before the pressure in the pipe becomes an excessive pressure. Thus, an excessive load on the pipe can be avoided. Accordingly, a pressure resistance required for the pipe can be reduced even if the fluid control valve is in an environment where an excessive pressure generates in the valve closed state of the fluid control valve.

Hereinafter, embodiments for implementing the present disclosure will be described referring to drawings. In each embodiment, portions corresponding to the elements described in the preceding embodiments are denoted by the same reference numerals, and redundant explanation may be omitted. When only a part of the configuration is described in each form, the other forms described above can be applied to the other parts of the configuration. It may be possible not only to combine parts which are explicitly described in each embodiment to be able to be combined specifically, but also to partially combine the embodiments without such explicit description unless there is a problem with the combination.

### First Embodiment

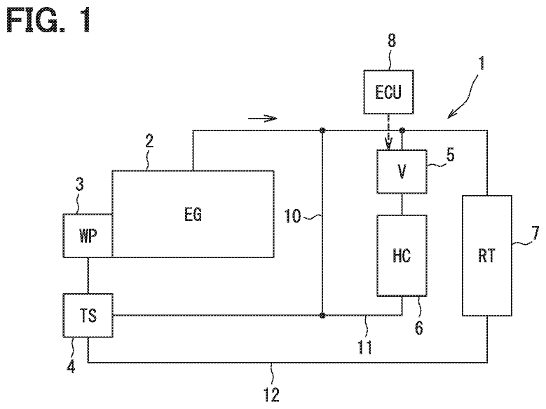

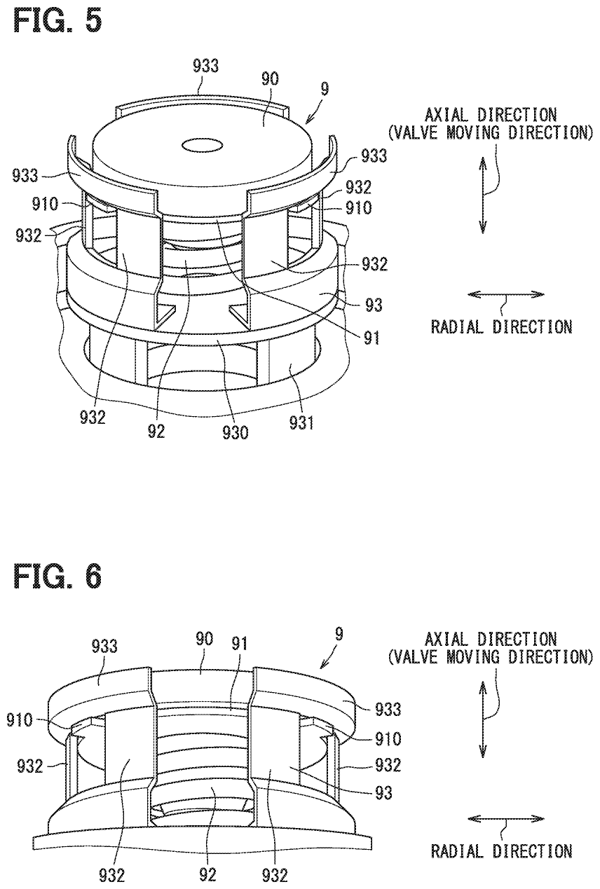

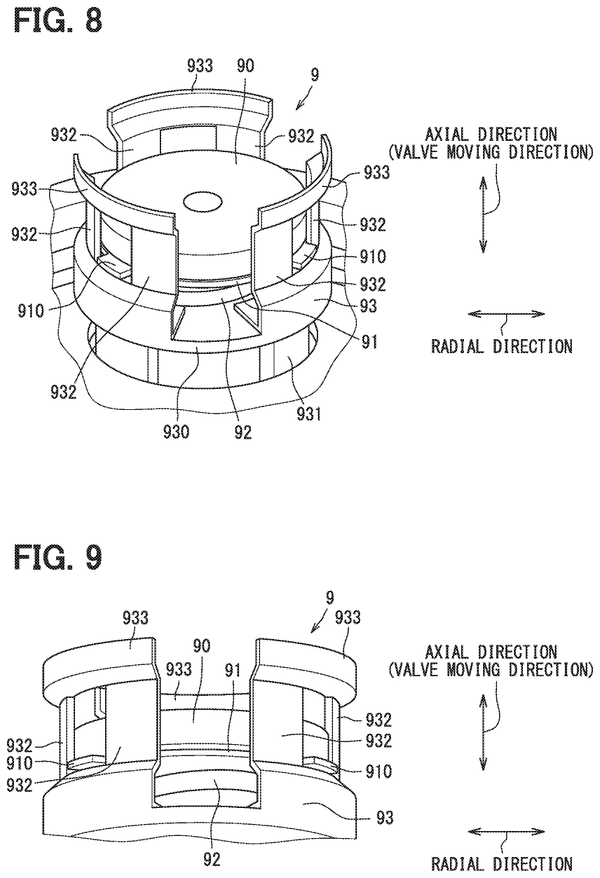

A first embodiment showing an example of a fluid control valve will be described with reference to FIGS. 1 to 9. A fluid control valve 5 of the first embodiment is disposed in a cooling water circuit 1. The fluid control valve 5 switches between a valve open state in which a fluid passage is open and a valve closed state in which the fluid passage is closed. A valve closing direction is defined as a direction opposite to a pressure direction of a working fluid flowing through the fluid control valve 5. The working fluid controlled by the fluid control valve 5 may be a liquid such as water or oil. The cooling water circuit 1 is a circuit through which engine cooling water circulates, and has a function of efficiently warming up and cooling an engine 2 provided in a vehicle. As shown in FIG. 1, the cooling water circuit 1 includes the engine 2, a pump 3, a first flow path 10, a second flow path 11, a third flow path 12, a switching valve 4, a heater core 6, a fluid control valve 5, a radiator 7, and a controller 8.

The cooling water flows out from the pump 3, flows through the engine 2, the first flow path 10, the second flow path 11, and the third flow path 12 and returns to the pump 3. The controller 8 includes at least one processor (CPU) and at least one memory device as a storage medium for storing a program and data. The controller 8 is provided by a microcontroller including a computer-readable storage medium. The storage medium is a non-transitional substantive storage medium that stores a computer-readable program in a non-temporary fashion. A semiconductor memory, a magnetic disk, or the like can serve as the storage medium. A computer 8 or a set of computer resources linked together by a data communication device can serve as the controller. When executed by the controller 8, the program causes the controller 8 to function according to the description provided herein and causes the controller 8 to perform the methods described herein. A functional unit of the controller 8 for performing various processes for warming up and cooling the engine 2 is made of hardware and/or software.

The pump 3 operates in conjunction with an operation of the engine 2 to drive the cooling water when the engine 2 is in an operating state. The pump 3 operates when the engine 2 is in the operating state to circulate the cooling water, and does not operate when the engine 2 is in a stopped state. As the pump 3, for example, a mechanical variable flow-rate pump operated by rotation of the engine is used. The pump 3 may be driven by an electric motor as a drive source and be operated and stopped regardless of the operating state of the engine 2. In this case, the pump 3 can change a discharge amount of fluid by control of the controller 8.

The first flow path 10 is a flow path in which the fluid circulates through the engine 2, the switching valve 4 and the pump 3 without passing through the heater core 6 and the radiator 7 so that the fluid flowing out from the engine 2 flows into the engine 2 through the pump 3. The engine 2 has therein a flow path through which the cooling water flows. The cooling water flowing inside the engine 2 absorbs heat of the engine 2 and raises its own temperature, thereby lowering the internal temperature of the engine 2. The second flow path 11 is a flow path in which the cooling water flowing out of the engine 2 branches from an upstream portion of the first flow path 10 and returns to a downstream portion of the first flow path 10 through the fluid control valve 5 and the heater core 6. The second flow path 11 is provided with the fluid control valve 5 and the heater core 6. The third flow path 12 is a flow path in which the cooling water branches from an upstream portion of the second flow path 11 that is upstream of the fluid control valve 5 and returns to a downstream portion of the first flow path 10 through the radiator 7.

The third flow path 12 is provided with the radiator 7. The switching valve 4 is provided at a junction where the third flow path 12 is connected to the downstream portion of the first flow path 10. The switching valve 4 is configured to be capable of switching the flow path of the cooling water that has flowed out of the engine 2 between a first state, a second state, and a third state. The first state is a state in which the first flow path 10 does not communicate with the third flow path 12 so that the cooling water circulates through the first flow path 10. The second state is a state in which the third flow path 12 and a passage leading to the engine are connected by the switching valve 4 so that the cooling water returns to the engine 2 through the third flow path 12. The third state is a state in which all the three passages connected to the switching valve 4 are open. For example, the switching valve 4 switches the flow path to the third state when the cooling water satisfies a predetermined temperature condition, and switches the flow path to the first state when the predetermined temperature condition is not satisfied. The switching valve 4 may include, for example, a thermostat valve. That is, an opening degree of the switching valve 4 may change according to an amount of heat (cooling water temperature) applied to temperature-sensitive wax.

The fluid control valve 5 is provided on an upstream side or a downstream side of the heater core 6 in the second flow path 11, and an opening degree of the fluid control valve 5 can be switched between two states: a closed state and an open state. When the fluid control valve 5 is in the closed state, the cooling water flows only through the first flow path 10 in the first state and flows only through the third flow path 12 in the second state, without flowing through the second flow path 11. When the fluid control valve 5 is in the open state, the cooling water flows through both the first flow path 10 and the second flow path 11 in the first state. As described above, the second flow path 11 and the third flow path 12 are in parallel with the first flow path 10.

The controller 8 controls the fluid control valve 5 based on a temperature of the cooling water detected by a coolant temperature sensor. After the engine 2 is started, when the cooling water temperature is lower than a predetermined first temperature, the switching valve 4 maintains the first state, and the controller 8 controls the fluid control valve 5 to the closed state. Since the cooling water circulates only through the first flow path 10, warm-up of the engine 2 is promoted.

When the cooling water temperature becomes equal to or higher than the first temperature, the warm-up control of the engine 2 is terminated. When the cooling water temperature becomes equal to or higher than a second temperature preset higher than the first temperature, the switching valve 4 switches from the first state to the second state or the third state, and the cooling water circulates through the third flow path 12 and releases heat in the radiator 7. When energization of the fluid control valve 5 is interrupted by the controller 8 and the fluid control valve 5 is controlled to be in the open state, the cooling water circulates through the second flow path 11 and releases heat also in the heater core 6. Further, in the first state, if the heater core 6 needs heat release from the cooling water, the energization of the fluid control valve 5 may be interrupted by the controller 8 to control the fluid control valve 5 to the open state.

As another example, the above-described cooling water circuit 1 may not include the first flow path 10 through which the fluid flowing out of the engine 2 returns to the engine 2 without passing through the heater core 6 or the radiator 7. The switching valve 4 may be configured to switch the flow path of the cooling water circuit 1 so as not to implement the above-described second state. The controller 8 may be configured to control the fluid control valve 5 based on a detection value of a sensor that detects an engine oil temperature or an oil temperature of a transmission or the like.

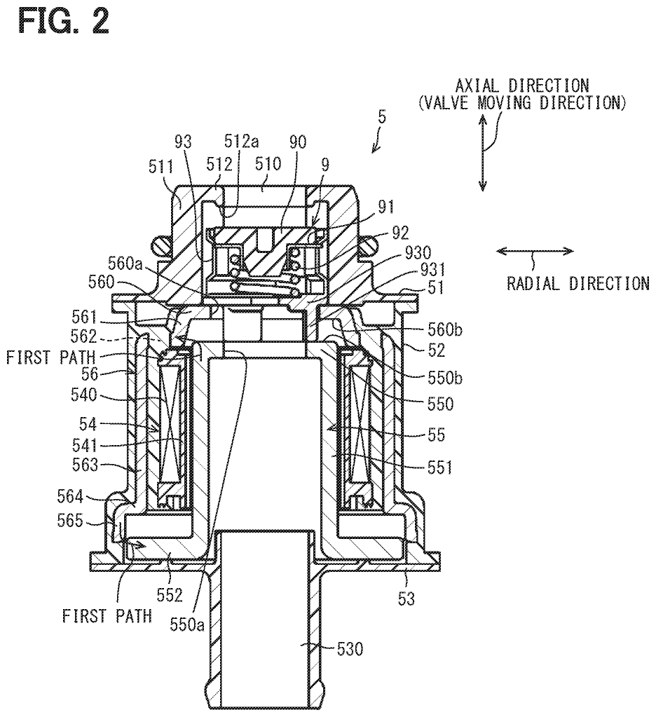

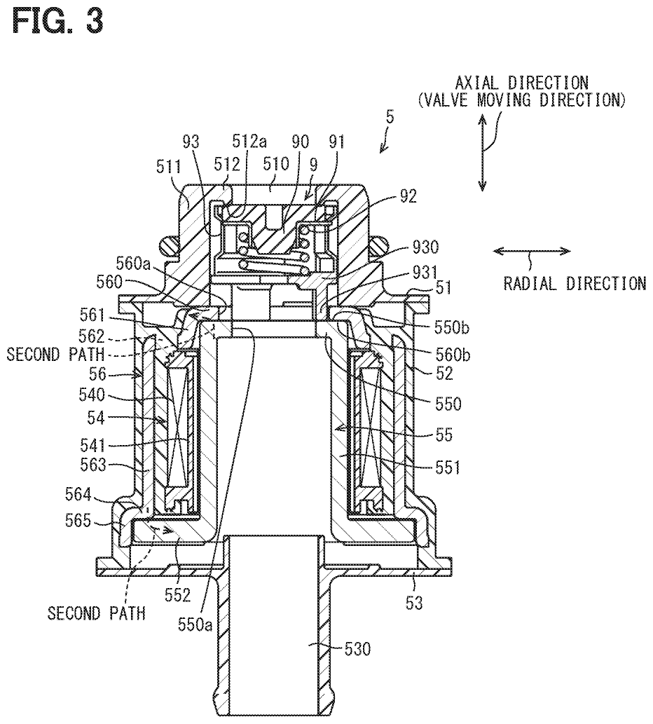

Hereinafter, the fluid control valve 5 will be described with reference to FIGS. 2 to 9. FIG. 2 shows the valve open state, and FIG. 3 shows the valve closed state. The fluid control valve 5 includes a relief valve assembly 9, a plunger 55 that is a movable core, a yoke 56, and an electromagnetic solenoid 54. The fluid control valve 5 is an electromagnetic valve having a configuration in which a pressure of working fluid acts in a valve opening direction in which a valve element 90 moves away from a valve seat 512a. That is, in the fluid control valve 5, the valve closing direction of the valve element 90 is set in a direction against the fluid pressure. The fluid control valve 5 opens or closes a fluid passage provided in a housing in accordance with balance between the fluid pressure received from the working fluid and a magnetic force generated by the energization of the fluid control valve 5. For example, the fluid passage includes an inflow port 510 provided in the inflow housing 51.

The relief valve assembly 9 is an example of a member that includes a relief valve mechanism. When an excessive fluid pressure occurs in the valve closed state of the valve element 90, the relief valve mechanism relieves the closed state of the fluid passage and cause the fluid to flow therethrough. The relief valve mechanism operates to allow the working fluid to flow through the fluid passage while maintaining a position of the plunger 55 in its axial direction when the fluid pressure exceeds a predetermined pressure in the valve closed state. The relief valve assembly 9 includes the valve element 90, a biasing member 92, and a support member 93. The relief valve assembly 9 is a relief valve mechanism unit that integrally includes the valve element 90 and the biasing member 92 as one body via the support member 93. The valve element 90 is an elastic member formed of an elastically deformable material such as rubber.

The plunger 55 has a cup-shaped body including a cylindrical portion 551 that has openings at different ends in the axial direction. The plunger 55 includes an upstream annular portion 550 provided at one end of the cylindrical portion 551 facing the valve element 90 or the inflow port 510, and a downstream annular portion 552 provided at another end of the cylindrical portion 551 facing an outflow port 530. The upstream annular portion 550 has the same outer diameter as that of the cylindrical portion 551, and has an upstream opening 550a as a through hole coaxial with the cylindrical portion 551. The upstream annular portion 550 supports the relief valve assembly 9 positioned upstream of the plunger 55 while the relief valve assembly 9 is movable in the axial direction.

An upstream surface of the upstream annular portion 550 contacts a downstream end portion of the support member 93 to support the support member 93 while the support member 93 is movable in the axial direction. The axial direction is also a moving direction of the valve element 90. As a result, the support member 93 moves in the axial direction together with the plunger 55. The downstream annular portion 552 is a flange portion that has a larger outer diameter than the cylindrical portion 551 and spreads radially in a direction orthogonal to the tubular portion 551. The downstream annular portion 552 has a downstream opening coaxial with the cylindrical portion 551 on an inner side of the downstream annular portion 552. The fluid passage, through which the working fluid flows in the valve open state, is provided inside the cylindrical portion 551. The fluid passage provided inside the cylindrical portion 551 communicates with the outflow port 530. The plunger 55 is made of, for example, a magnetic material.

The plunger 55 is supported by the yoke 56 so as to be slidable in the axial direction in a state where at least the downstream annular portion 552 is inserted into a second cylindrical portion 565 positioned at a downstream end of the yoke 56. Alternatively, at least the cylindrical portion 551 may be partially supported by a sliding support portion provided inside a bobbin 541 such that the plunger 55 is slidable in the axial direction. The bobbin 541 and the sliding support portion are formed of a nonmagnetic material.

A housing main body forming the fluid passage in the fluid control valve 5 includes the inflow housing 51 provided with the inflow port 510 as an inflow passage through which the working fluid flows thereinto, and an outflow housing 53 provided with the outflow port 530 as an outflow passage through which the working fluid flows out thereof, and an intermediate housing 52. The intermediate housing 52 connects the inflow housing 51 and the outflow housing 53. A flange portion provided at a downstream end of the inflow housing 51 is integrally coupled to the intermediate housing 52.

The inflow housing 51 includes an upstream annular portion 512 that forms an inlet portion of the inflow port 510, a cylindrical portion 511 that extends in the axial direction from an outer peripheral edge of the upstream annular portion 512, and the flange portion that spreads radially from a downstream end portion of the cylindrical portion 511 in a direction orthogonal to the cylindrical portion 511. The inflow housing 51 includes the valve seat 512a provided around the inlet portion of the inflow port 510 and on an inner wall of an inner peripheral edge of the upstream annular portion 512. The valve element 90 moving in the valve closing direction sits on the valve seat 512a. In the valve-closed state, the valve seat 512a is in contact with the valve element 90 so as to form an annular contact surface or an annular contact line therebetween. The inflow housing 51 houses the relief valve assembly 9 inside the cylindrical portion 511 such that the relief valve assembly 9 is slidable in the axial direction.

A flange portion provided at an upstream end of the outflow housing 53 is integrally coupled to the intermediate housing 52. The inflow housing 51, the intermediate housing 52, and the outflow housing 53 are formed of a resin material, and are welded at their joint portions.

The intermediate housing 52 includes the yoke 56, the plunger 55, a coil 540, and the bobbin 541. As shown in FIG, 2, the intermediate housing 52 houses a downstream part of the relief valve assembly 9 in the valve open state and the valve closed state. The yoke 56 is made of, for example, a magnetic material, similar to the plunger 55. The yoke 56 constitutes a part of a magnetic circuit, and supports the bobbin 541 and the plunger 55 inside the intermediate housing 52. The yoke 56 covers the outer peripheral sides of the bobbin 541 and the coil 540. The yoke 56, the plunger 55, the coil 540, the bobbin 541 and the sliding support portion are coaxial.

The electromagnetic solenoid 54 includes the yoke 56, the coil 540, the bobbin 541, the sliding support portion and a connector. The connector is positioned on a lateral side or outside of the yoke 56. The connector is provided for energizing the coil 540, and includes an internal terminal electrically connected to the coil 540. The electromagnetic solenoid 54 is capable of controlling a current that energizes the coil 540 by electric connection between the terminal and the controller 8 through the connector. The bobbin 541 is formed in a cylindrical shape from a resin material, and the coil 540 is wound around the outer peripheral surface of the bobbin 541. When the coil 540 is energized, a generated magnetic flux forms a magnetic circuit so as to circulate through the yoke 56 and the plunger 55.

The yoke 56 is a cylindrical body that has openings at different ends in the axial direction. The yoke 56 includes a first annular portion 560 provided at an upstream end of the yoke 56 and facing the inflow port 510, an inclined portion 561 inclined with respect to the axis of the plunger 55, and a second annular portion 562 extending radially outward from a downstream portion of the inclined portion 561. The yoke 56 further includes a first cylindrical portion 563 extending in the axial direction from an outer peripheral edge of the second annular portion 562, a second cylindrical portion 565 provided at a downstream end of the yoke 56 and having a sectional shape extending in the axial direction, and a downstream annular portion 564 connecting the first cylindrical portion 563 and the second cylindrical portion 565. The downstream annular portion 564 extends radially outward from a downstream end portion of the first cylindrical portion 563, and an outer peripheral side of the downstream annular portion 564 is integrated with the second cylindrical portion 565.

The first annular portion 560 is capable of contacting the upstream annular portion 550 of the plunger 55 in the axial direction, has a larger diameter than the upstream annular portion 550, and has an opening 560a as a through hole coaxial with the upstream opening 550a of the plunger 55. The first annular portion 560 and the upstream annular portion 550 are parallel portions to face each other in the axial direction and having sectional shapes extending along each other. Hereinafter, the sectional shapes related to the inclined portion and the parallel portions mean vertical sectional shapes taken along the axial direction of the plunger or the like. In the valve closed state in which the valve element 90 is in contact with the valve seat 512a, a downstream surface 560b of the first annular portion 560 that faces away from the valve element 90 is in contact with or close to an upstream surface 550b of the upstream annular portion 550 that faces the valve element 90.

The downstream surface 560b and the upstream surface 550b are parallel portions to face each other in the axial direction and extending along each other. As shown in FIG. 3, in the valve-closed state, a second path is formed as a magnetic path through which a magnetic flux passes through a portion where the first annular portion 560 and the upstream annular portion 550 are in contact with or close to each other.

The inclined portion 561 is a cylindrical portion having an upstream end connected to the first annular portion 560 and a downstream end connected to the second annular portion 562. The inclined portion 561 has a sectional shape inclined with respect to the cylindrical portion 551 of the plunger 55. The inclined portion 561 is formed such that the upstream end has a smaller diameter than the downstream end. Therefore, the inclined portion 561 is inclined with respect to the cylindrical portion 551 so that the diameter increases in the downstream direction.

The upstream end of the inclined portion 561 has a larger diameter than the cylindrical portion 551. Accordingly, the cylindrical portion 551, particularly the upstream portion thereof, is positioned such that a distance to the inclined portion 561 gradually decreases with movement from the valve open state shown in FIG. 2 to the valve closed state shown in FIG. 3. At a start of energization in the valve open state, as shown in FIG. 2, a distance between the inclined portion 561 and the cylindrical portion 551 is shortest in the distance between the plunger 55 and the yoke 56 in their upstream parts. Accordingly, when the valve is open and energized, a first path, which is a magnetic path through which the magnetic flux passes between the inclined portion 561 and the cylindrical portion 551, has a larger magnetic flux than the above-described second path. As described above, when energization is started in the valve open state, a magnetic path is formed such that the first path is larger in magnetic flux than the second path. In the valve closed state, a magnetic path is formed such that the second path is larger in magnetic flux than the first path.

As shown in FIG. 2, when the valve is open and energized, the magnetic flux passes through the first path between the downstream annular portion 552 and the second cylindrical portion 565 at the downstream end of the plunger 55 and the yoke 56. In the valve open state, a distance between the downstream annular portion 552 and the second cylindrical portion 565 is shortest in the distance between the plunger 55 and the yoke 56 in their downstream parts.

When the valve open state shown in FIG. 2 is approached to the closed state and becomes the valve closed state shown in FIG. 3, a reverse phenomenon occurs in which the second path becomes more dominant than the first path. This is because the downstream annular portion 552 and the downstream annular portion 564 forming the parallel portions become in contact with each other, or become closest to each other between the plunger 55 and the yoke 56 in their downstream parts. In the downstream parts of the plunger 55 and the yoke 56, a portion between the downstream annular portion 552 and the downstream annular portion 564 is smallest in magnetic resistance and largest in magnetic flux.

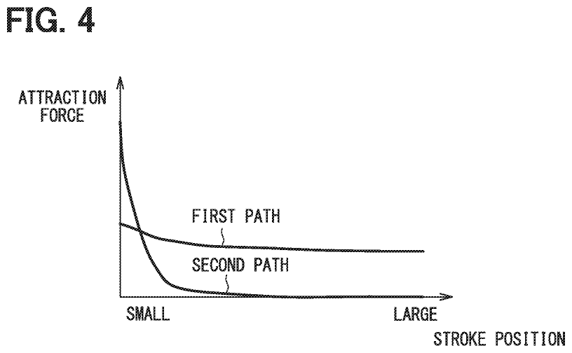

As shown in FIG. 4, the attraction force for attracting the plunger 55 is larger in the first path than in the second path while the valve open state approaching the valve closed state, and the reverse phenomenon occurs immediately before the valve closed state. In the valve closed state, the attraction force is larger in the second path than in the first path. As shown in FIG. 4, in the fluid control valve 5, the attraction force attracting the plunger 55 is greater in the first path than in the second path in the valve open state in which the valve element 90 and the valve seat 512a are largely separated from each other, i.e, a stroke position is large. Therefore, since the fluid control valve 5 adopts such configuration where the attraction of the plunger 55 starts by the first path, the plunger 55 can be attracted against the fluid pressure acting on the valve element 90, thereby enhancing the attraction performance at the start of energization.

As shown in the characteristic diagram of FIG. 4, in the fluid control valve 5, the attraction force attracting the plunger 55 becomes larger in the second path than the first path immediately before the valve closed state where the stroke position is small. Therefore, since the fluid control valve 5 adopts such configuration where the valve element 90 is attracted to and made to contact the valve seat 512a by the magnetic force via the second path, the valve element 90 can be closed against the fluid pressure acting on the valve element 90, thereby enhancing the attraction holding force at the time of valve closing. As described above, the fluid control valve 5 provides an electromagnetic valve having advantageous characteristics related to the attraction forces of both the first path illustrated by the solid arrows in FIG. 2 and the second path illustrated by the broken arrows in FIG. 3.

The relief valve assembly 9 will be described with reference to FIGS, 2, 3, and 5 to 9. The support member 93 of the relief valve assembly 9 integrally supports the biasing member 92 and a valve element support portion 91 in which a shaft portion and a back surface of a disc portion of the valve element 90 are fitted. The support member 93 is made of a material that is difficult to pass magnetism, such as a resin material or stainless steel. Therefore, the support member 93 is configured not to form a magnetic circuit.

In the relief valve assembly 9, the valve element 90, the valve element support portion 91, the biasing member 92, and the support member 93 are coaxially disposed. The valve element support portion 91 includes an annular portion located on an upstream side of the valve element support portion 91, and a cylindrical portion extending in the axial direction from an inner peripheral edge of the annular portion. In the valve element support portion 91, the annular portion is in contact with the back surface of the disc portion of the valve element 90, and the cylindrical portion is in contact with an outer peripheral surface of the shaft portion of the valve element 90 to support the valve element 90.

The biasing member 92 has a function of urging the valve element 90 and the valve element support portion 91 in a direction opposite to the direction in which the valve element 90 moves to the valve open state. At least a coil spring, a plate spring, or another member formed of elastically deformable material can be used as the biasing member 92. Regardless of energization, when a fluid pressure that overcomes the biasing force is applied to the valve element 90, the biasing member 92 contracts to reduce its own size in the axial direction, and the valve element 90 becomes a relief state by moving away from the valve seat 512a.

The biasing member 92 biases the valve element support portion 91 in a direction toward the inflow port 510 or the upstream direction. In an example illustrated in the first embodiment, a coil spring is used as the biasing member 92. As shown in FIGS, 3, 5, and 6, the cylindrical portion of the valve element support portion 91 is inserted inside the biasing member 92. In this state, the biasing member 92 is compressed and held such that a length of the biasing member 92 in the axial direction is reduced from its natural length by the annular portion of the valve element support portion 91 and the support member 93. The biasing member 92 urges the valve element 90 in the axial direction in a state where the length of the biasing member 92 in the axial direction is shorter than the natural length. The plunger 55 moves in the axial direction largely due to the deformation of the biasing member 92 rather than the deformation of the valve element 90 during a valve closing process from contact between the valve element 90 and the valve seat 512a to a completion of the valve closing through elastic deformation of the valve element 90 without fluid pressure applied to the valve element 90. The biasing member 92 is designed to provide the valve element 90 with a biasing force that satisfies such a condition.

As shown in FIGS, 7 to 9, when a fluid pressure exceeding a predetermined pressure is applied to the valve element 90 in the valve closed state, the valve element 90 is pushed downstream so that the biasing member 92 is further elastically deformed and compressed in the axial direction. By such elastic deformation, the valve element 90 becomes in the relief state in which the valve element 90 is displaced downstream, thereby allowing the working fluid to flow in the fluid passage and reducing the fluid pressure in a pipe connected to an upstream side of the fluid control valve 5.

The support member 93 integrally supports the valve element 90 and the biasing member 92 such that the valve element 90 is movable in the axial direction. The support member 93 includes a base 930 that supports a downstream end of the biasing member 92 in the axial direction, multiple legs 931 that protrude downstream from the base 930, multiple lateral walls 932 that extend upstream from the base 930, and a web 933 located at an upstream end portion of the support member 93. The valve element support portion 91 includes multiple protrusion strips 910 that individually protrude radially outward from an outer peripheral edge of the annular portion of the valve element support portion 91. The protrusion strips 910 is engaged with the support member 93 in a state in which the protrusion strips 910 is prevented from moving upstream by the web 933 between two of the lateral walls 932 connected by the web 933. The valve element support portion 91 is fixed to the support member 93 when the protrusion strips 910 are engaged with the support member 93 and the movement toward the inflow port 510 is restricted.

The multiple legs 931 are provided at intervals in the circumferential direction. Downstream ends of the multiple legs 931 are supported in the axial direction by the plunger 55. The legs 931 are supported slidably in the axial direction while the legs are inserted into the opening 560a of the first annular portion 560 of the yoke 56. The legs 931 are in contact with the first annular portion 560, whereby displacement of the support member 93 in the radial direction is restricted. The base 930 is in contact with the first annular portion 560 in the valve open state, and the support member 93 is thereby restricted from moving further downstream. Therefore, the support member 93 is restricted by the yoke 56 such that the support member 93 is movable within a predetermined range in the axial direction and substantially immovable in the radial direction. A space between two of the legs 931 adjacent to each other in the circumferential direction communicates with the outflow port 530 through a passage inside the cylindrical portion 551. Since the inflow port 510 communicates with the space between the adjacent legs 931 in the relief state, the inflow port 510 and the outflow port 530 communicate with each other, and the fluid pressure in the pipe decreases.

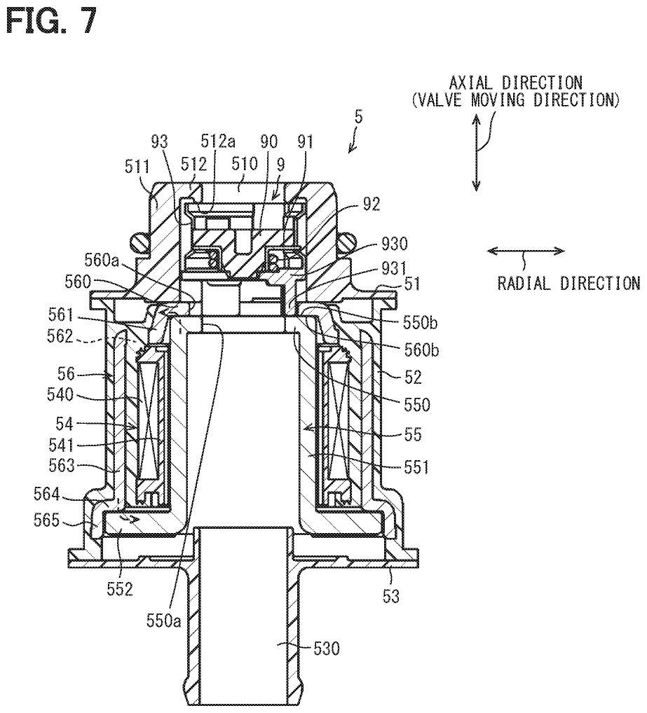

The web 933 connects at least two lateral walls 932. The support member 93 includes multiple or single web 933. As shown in FIGS. 2, 3, 5, and 6, the web 933 is positioned radially outward of an outer edge of the valve element 90 and extends along the outer edge of the valve element 90 in the valve closed state. As shown in FIGS. 7 to 9, the multiple lateral walls 932 are positioned radially outward of the outer edge portion of the valve element 90 when the biasing member 92 is greatly compressed in the axial direction and the valve element 90 is separated away from the valve seat 512a, Therefore, the valve element 90 moves between the valve closed state shown in FIG. 3 and the relief state shown in FIG. 7 in accordance with change in the length of the biasing member 92 in the axial direction depending on the fluid pressure acting on the valve element 90.

Next, effects provided by the fluid control valve 5 of the first embodiment will be described. The fluid control valve 5 includes a housing having a fluid passage through which a working liquid fluid flows, and a valve element 90 that is provided inside the housing and opens and closes the fluid passage by switching between a valve open state and a valve closed state. The fluid control valve 5 includes a plunger 55 provided inside the housing and movable in the axial direction to drive the valve element 90, a coil 540 provided inside the housing and generating a magnetic force for moving the plunger 55 in the axial direction, and a relief valve mechanism. The relief valve mechanism operates to allow the working fluid to flow through the fluid passage while maintaining a position of the plunger 55 in its axial direction when the fluid pressure exceeds a predetermined pressure in the valve closed state.

Since the fluid control valve 5 includes the relief valve mechanism that operates in the above manner, even when a pressure in the pipe connected to the fluid control valve 5 increases, the working fluid starts flowing through the fluid passage before the pressure in the pipe becomes an excessive pressure. Accordingly, since an excessive load on the pipe can be avoided, a pressure resistance required for the pipe can be reduced even if an excessive pressure generates in the closed state of the fluid control valve.

The relief valve mechanism includes the biasing member 92 urging the valve element 90 in a direction opposite to the direction in which the valve element 90 moves to the valve open state. The biasing member 92 operates to allow the working fluid to flow through the fluid passage when the fluid pressure exceeds a predetermined pressure in the valve closed state. According to the fluid control valve 5, the pressure acting on the pipe in the valve closed state can be controlled by setting the biasing force of the biasing member 92.

The fluid control valve 5 includes the support member 93 that integrally supports the valve element 90 and the biasing member 92 such that the valve element 90 is movable in the axial direction. According to this configuration, the relief valve mechanism unit that integrally includes the valve element 90 and the biasing member 92 as one body via the support member 93 can be provided. Therefore, a relief valve mechanism unit can be selected from among multiple relief valve mechanism units with different product performance such as biasing force and attached to the fluid control valve 5 in accordance with the pressure resistance performance of the pipe.

Furthermore, the plunger 55 drives the support member 93 in the axial direction while the plunger 55 keeping in contact with the support member 93. According to the fluid control valve 5, the driving force of the plunger 55 can be directly transferred to the behavior of the valve element 90. Accordingly, in the fluid control valve 5, the valve closed state can be directly related to the attraction force related to the yoke 56 and the like and the plunger 55,

The valve element 90, the support member 93, the biasing member 92, and the plunger 55 are provided coaxially. According to this configuration, since these components are arranged coaxially, the size of the fluid control valve 5 in the direction orthogonal to the axial direction can be reduced, which contributes to reduction in flow resistance of the working fluid.

The valve element 90 is formed of an elastically deformable material such as rubber. The biasing member 92 urges the valve element 90 in the axial direction while the length of the biasing member 92 in the axial direction is kept shorter than its natural length. The displacement of the plunger 55 in the axial direction due to the deformation of the biasing member 92 may be set larger than the displacement of the plunger 55 due to the deformation of the valve element 90 during a valve closing process from a contact between the valve element 90 and the valve seat 512a to a completion of valve closing through elastic deformation of the valve element 90 without fluid pressure applied to the valve element 90.

According to the fluid control valve 5, when the valve closing is completed, it is possible to realize the valve closed state in which the valve element 90 is pressed against the valve seat 512a mainly by the biasing force of the biasing member 92. The valve element 90, which is a material that is easily elastically deformed, has a property that the change in the load applied to the valve seat 512a during the axial deformation process is larger than that of the biasing member 92. In order to reduce this load change and obtain a stable valve closed state, there is a method of increasing the magnetic force for driving the valve element 90, but this method has a concern that the coil 540 becomes large in size. Since the fluid control valve 5 completes the valve closing action while reducing the deformation amount of the valve element 90 and largely deforming the biasing member 92, the load change given to the valve seat 512a in the axial deformation process can be reduced. Thus, since the fluid control valve 5 is capable of reducing the magnetic force for driving the valve element 90, enlargement of the coil 540 can be reduced and the stable valve closed state can be provided.

The fluid control valve 5 includes the first path that is a magnetic path through which the magnetic flux passes between the plunger 55 and the yoke 56, and the second path that is a magnetic path through which the magnetic flux passes between the plunger 55 and the yoke 56 at a position different from the first path. When energization is started in the valve open state, a magnetic path is formed such that the first path is larger in magnetic flux than the second path. In the valve closed state, a magnetic path is formed such that the second path is larger in magnetic flux than the first path.

According to the fluid control valve 5, when energization is started in the valve open state, attraction of the plunger 55 can be started against the fluid pressure by using the driving force generated by the magnetic flux passing through the first path having a larger magnetic flux than the second path. Further, in the process from the valve open state to the valve closed state, the plunger 55 is attracted to the yoke 56 and the valve closed state can be maintained by using the driving force generated by the magnetic flux passing through the second path having a lager magnetic flux than the first path. Thus, the first path becomes dominant as a magnetic path when the energization is started in the valve open state. Hence, the attracting force that attracts the plunger 55 toward the yoke 56 can be exerted, and a driving force for moving the plunger 55 in a direction against the pressure of the working fluid can be obtained. In the valve closed state, the second path becomes dominant as a magnetic path, so that the attracting force for maintaining the plunger 55 in contact with the yoke 56 can be exerted to keep the fluid passage closed. Therefore, the fluid control valve 5 can improve a valve closing performance against the pressure of the working fluid. Furthermore, the fluid control valve 5 can achieve both valve closing from the valve open state and maintaining of the closed state without depending on an urging force of a spring or the like. Thus, increase in size due to addition of the spring or enhancement of urging force can be reduced,

The fluid control valve 5 has a configuration in which a magnetic circuit is formed by the plunger 55 and the yoke 56. Thereby, it contributes to suppression of the number of parts of the device, and further, the air gap in the magnetic circuit can be reduced.

The fluid control valve 5 may be controlled to a maximum voltage at the start of energization in the valve open state (i.e. at the start of attraction), and may be controlled to a voltage lower than that at the start of attraction in the valve closed state (i.e. at the time of holding attraction). When this control is adopted, the fluid control valve 5 can achieve the attraction start and the attraction holding even if the energized voltage is reduced because the fluid control valve 5 includes the first path and the second path described above.

The second path is formed in the parallel portions of the plunger 55 and the yoke 56 facing each other in the axial direction and having sectional shapes extending along each other. Such parallel portions have a large facing area or a large contact area between the plunger 55 and the yoke 56, and thus can form the second path with a large magnetic flux. Accordingly, the fluid control valve 5 can have a valve function at a position where the attractive force of the magnetic force acts, and can improve a valve shutting-off performance.

In the fluid control valve 5, the second path is set at multiple positions. At least one of the second paths set in the multiple positions may be formed in a part where the plunger 55 and the yoke 56 are in contact with each other when the valve is closed. Since at least one of the multiple second paths is provided at the part where the plunger 55 and the yoke 56 are in contact with each other, the attraction force capable of maintaining the valve closed state against the fluid pressure can be provided, and the attraction holding force in the valve closed state can be strengthened.

The fluid control valve 5 includes a fluid passage through which the working fluid flows inside the plunger 55. According to this configuration, in the fluid control valve 5, heat generated from the plunger 55 due to energization thereof can be relieved by the working fluid.

The fluid control valve 5 includes the fluid passage through which the working fluid flows inside the plunger 55 and inside the coil 540. According to this configuration, in the fluid control valve 5, heat generated from the plunger 55 and the coil 540 due to energization thereof can be relieved by the working fluid.

The fluid control valve 5 may include a fluid passage through which the working fluid flows outside the plunger 55 and inside the coil 540. According to this configuration, in the fluid control valve 5, heat generated from the plunger 55 and the coil 540 due to energization thereof can be relieved by the working fluid flowing therebetween.

### Second Embodiment

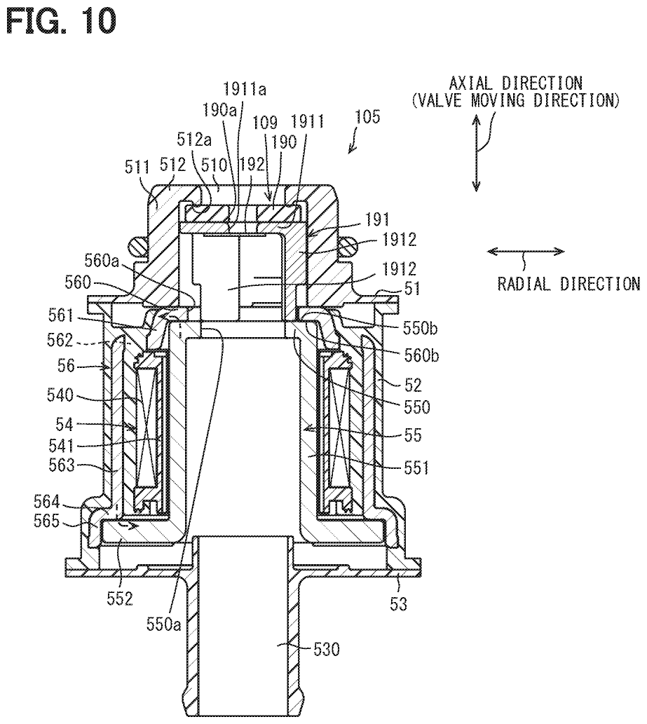

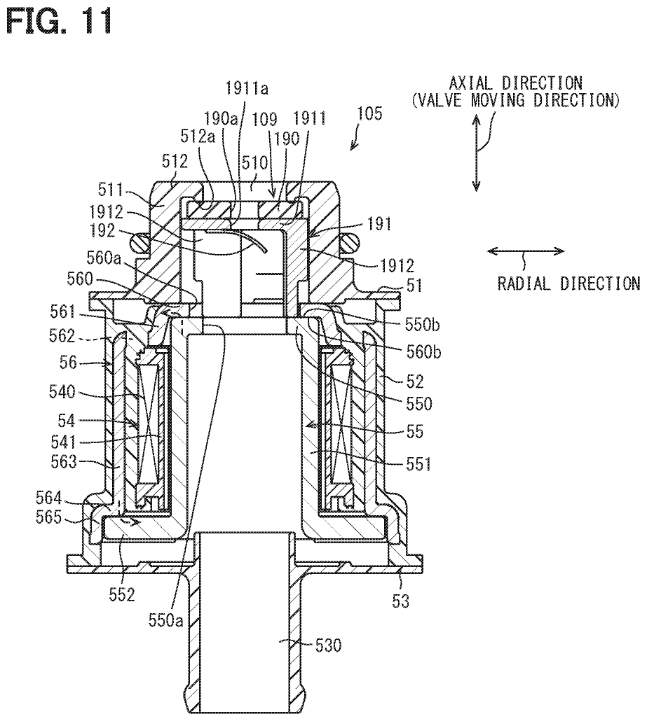

A second embodiment will be described with reference to FIGS. 10 and 11. A fluid control valve 105 of the second embodiment is different from the first embodiment in the relief valve assembly 109. In the following description, explanations for configurations, operations and effects of the second embodiment that are the same as those of the first embodiment will be omitted. That is, features of the second embodiment different from those of the first embodiment will be described hereafter.

The fluid control valve 105 includes the relief valve assembly 109 that includes a valve element 190, a support member 191, and an auxiliary valve 192. The relief valve assembly 109 is an example of a member that includes a relief valve mechanism. When an excessive fluid pressure occurs in a valve closed state of the valve element 190, the relief valve mechanism relieves the closed state of the fluid passage and cause the fluid to flow therethrough. When the fluid pressure exceeds a predetermined pressure in the valve closed state, the relief valve mechanism operates to allow the working fluid to flow through the fluid passage while maintaining a position of a plunger 55 in its axial direction and maintaining the valve element 190 seated on a valve seat 512a.

The support member 191 includes a valve support 1911 provided at the upstream end portion of the support member 191, and multiple lateral walls 1912 extending in the axial direction from an outer peripheral edge of the valve support 1911. The valve support 1911 is a disc-shaped upstream plate portion. The multiple lateral walls 1912 are provided at intervals in the circumferential direction. A space between two of the lateral walls 1912 adjacent to each other in the circumferential direction communicates with an outflow port 530 through a passage inside a cylindrical portion 551.

The valve element 190 is mounted on an upstream surface of the valve support 1911, and the auxiliary valve 192 is mounted on a downstream surface of the valve support 1911. The valve support 1911 supports the valve element 190 on the upstream side of the disc shape of the valve support 1911 and supports the auxiliary valve 192 downstream of the valve element 190. The auxiliary valve 192 is a plate-shaped valve, one end of the auxiliary valve 192 is fixed to the valve support 1911, and another end of the auxiliary valve 192 is not fixed as a free end. As shown in FIG. 10, the other end of the auxiliary valve 192 which is the free end is in contact with the valve support 1911 and closes a relief passage 1911a when fluid pressure is not acting on the auxiliary valve 192 in the downstream direction. As shown in FIG, 11, the other end of the auxiliary valve 192 is separated from the valve support 1911 to open the relief passage 1911a by elastic deformation of the auxiliary valve 192 when the fluid pressure acting on the auxiliary valve 192 exceeds a predetermined pressure.

The valve element 190 is provided with a relief passage 190a which extending in the axial direction through the valve element 190. The valve support 1911 is provided with the relief passage 1911a which extending in the axial direction through the valve support 1911. The relief passage 190a and the relief passage 1911a are arranged in the axial direction, and function as a relief passage that allows fluid to flow from an inflow port 510 to the outflow port 530 when the auxiliary valve 192 is open. The auxiliary valve 192 functions as a mechanical valve that opens and closes the relief passage on the downstream side of the valve support portion 1911.

An upstream surface of an upstream annular portion 550 contacts downstream end portions of the lateral walls 1912 of the support member 191 to support the support member 191 while the support member 191 is movable in the axial direction. As a result, the support member 191 moves in the axial direction together with the plunger 55 as a single unit.

The lateral walls 1912 are supported and slidable in the axial direction while the lateral walls 1912 are inserted into an opening 560a of a first annular portion 560 of a yoke 56. The lateral walls 1912 has a step that engages with the first annular portion 560 in the valve open state, and thereby the support member 191 is restricted by the step from further moving in the downstream direction, i.e. the valve opening direction, in the valve open state. Therefore, the relief valve assembly 109 is restricted by the yoke 56 such that the relief valve assembly 109 is movable within a predetermined range in the axial direction and substantially immovable in the radial direction. The support member 191 is made of a material that is difficult to pass magnetism, such as a resin material or stainless steel. Therefore, the support member 191 is configured not to form a magnetic circuit.

According to the second embodiment, the relief valve mechanism includes the relief passage through which the working fluid is capable flowing even when the valve element 190 is in the valve closed state, and includes the auxiliary valve 192 that closes the relief passage. The auxiliary valve 192 is pushed and opens the relief passage by the fluid pressure and allows the working fluid to flow through the fluid passage when the fluid pressure exceeds a predetermined pressure in the valve closed state of the valve element 190. According to the fluid control valve 105, such relief state can be provided while maintaining the valve element 190 in the closed state, and thereby the fluid pressure can be reduced. For example, even if the valve element 190 and the plunger 55 are fixed and difficult to move, the auxiliary valve 192, which is a separate component from the valve element 190, has a configuration that opens the relief passage. Thus, even if a trouble occurs in the valve element 190, the relief state can be reliably obtained.

The auxiliary valve 192 is a member that is elastically deformed by the acting fluid pressure and opens the relief passage. Since the relief state can be provided by appropriately setting the material, shape, thickness dimension, and the like of the auxiliary valve 192, a relief valve mechanism having a simple configuration can be provided.

The relief valve mechanism includes the support member 191 having the valve support 1911 that supports the valve element 190 on the upstream side of the disc shape of the valve support 1911 and supports the auxiliary valve 192 downstream of the valve element 190. The plunger 55 drives the support member 191 in the axial direction while the plunger 55 keeping in contact with the support member 191. The relief passage constitutes a passage extending through the valve element 190 and the valve support 1911. According to the fluid control valve 105, in the valve closing state where the valve element 190 is seated on the valve seat 512a, the fluid flows into the relief passage extending through the valve element 190 and the valve support 1911 and pushes the auxiliary valve 192 open. According to the configuration, the fluid pressure in the pipe can be reduced.

The valve element 190, the support member 191, the auxiliary valve 192, and the plunger 55 are positioned to overlap each other in the flow direction of the working fluid. According to the fluid control valve 105, the size of the fluid control valve 105 in the direction orthogonal to the direction along the fluid passage inside the housing can be reduced, and a flow resistance of the working fluid can be reduced.

### Third Embodiment

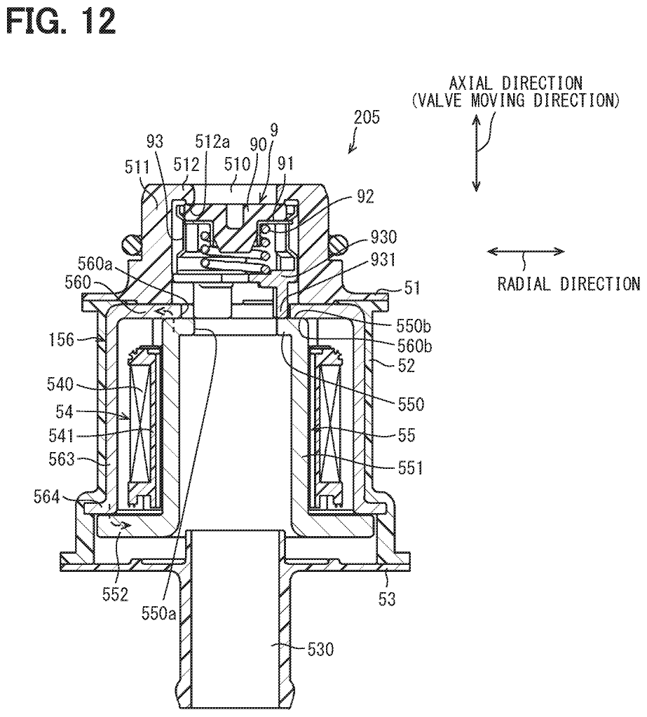

A third embodiment will be described with reference to FIG. 12. A fluid control valve 205 of the third embodiment is different from the first embodiment in configuration of a yoke 156. In the following description, explanations for configurations, operations and effects of the third embodiment that are the same as those of the first embodiment will be omitted. That is, features of the third embodiment different from those of the first embodiment will be described hereafter.

The yoke 156 includes a first annular portion 560 provided on an upstream side of the yoke 156 facing an inflow port 510, a first cylindrical portion 563 extending in the axial direction from an outer peripheral edge of the first annular portion 560, and a downstream annular portion 564. The downstream annular portion 564 has a flange shape extending radially outward from a downstream end portion of the first cylindrical portion 563.

The fluid control valve 205 does not form the first path as in the first embodiment due to the shape of the yoke 156. The fluid control valve 205 approaches a closed state from a valve open state, and then forms a second path illustrated by a broken line when the fluid control valve 205 becomes the closed state shown in FIG. 12. This is because a second path similar to that of the first embodiment is formed by upstream parts of the plunger 55 and the yoke 156, and a downstream annular portion 552 of the plunger 55 and the downstream annular portion 564 which are parallel portions become in contact with each other, or become closest to each other between the plunger 55 and the yoke 156 in their downstream parts.

### Other Embodiments

The disclosure of this specification is not limited to the illustrated embodiment. The disclosure encompasses the illustrated embodiments and modifications by those skilled in the art based thereon. The present disclosure is not limited to combinations disclosed in the above-described embodiment but can be implemented in various modifications. The present disclosure can be implemented in various combinations. The disclosure may have additional parts that may be added to the embodiment. The disclosure encompasses omissions of parts and/or elements of the embodiments. The disclosure encompasses replacement or combination of parts and/or elements between one embodiment and another. The disclosed technical scope is not limited to the description of the embodiment. Technical scopes disclosed are indicated by descriptions in the claims and should be understood to include all modifications within the meaning and scope equivalent to the descriptions in the claims.

The third embodiment can be applied not only to the fluid control valve of the first embodiment but also to the fluid control valve including the relief valve assembly 109 of the second embodiment.

The fluid control valve 5 that can achieve the object disclosed in the specification does not limit the first path and the second path to the positions described in the above-described embodiments. Each of the above-described embodiments may be configured such that the shapes of the plunger and the yoke related to the magnetic path are reversed between their upstream sides and their downstream sides.

In the fluid control valve according to each of the above-described embodiments, the controller 8 may be a duty-cycle control valve that controls a ratio of ON time to a one cycle time consisting of the ON time and OFF time of energization, i.e. duty cycle, for energizing the electromagnetic coil. According to such energization control for the fluid control valve, a flow rate of cooling water flowing through the second flow path 11 can be arbitrarily adjusted.

The fluid control valve that can achieve the object disclosed in the specification is not limited to an electromagnetic valve that can control the flow rate of the cooling water in the cooling water circuit 1 in which the cooling water of the engine 2 circulates. This fluid control valve is, for example, an electromagnetic valve that controls a flow rate of a working fluid that can cool a motor, an inverter, a semiconductor device, etc., an electromagnetic valve that controls a flow rate of a working fluid used for air cooling or air heating, and a solenoid valve that controls a flow of a working oil such as automatic oil.

What is claimed is:

1. A fluid control valve comprising:
a housing having a fluid passage through which a liquid working fluid flows;
a valve element provided inside the housing and configured to be switched between a valve open state to open the fluid passage and a valve closed state to close the fluid passage;
a plunger provided inside the housing and moved in an axial direction to drive the valve element;
a coil provided inside the housing and configured to generate a magnetic force that moves the plunger in the axial direction; and
a relief valve mechanism configured to allow the working fluid to flow through the fluid passage with keeping a position of the plunger in the axial direction when a fluid pressure of the working fluid exceeds a predetermined pressure in the valve closed state.

2. The fluid control valve according to claim 1, wherein
the relief valve mechanism includes a biasing member urging the valve element in a direction opposite to a direction in which the valve element moves toward the valve open state, and
the biasing member is configured to allow the working fluid to flow through the fluid passage when the fluid pressure exceeds the predetermined pressure in the valve closed state.

3. The fluid control valve according to claim 2, comprising
a support member integrally supports the valve element and the biasing member such that the valve element is movable in the axial direction.

4. The fluid control valve according to claim 3, wherein
the plunger is in contact with the support member while moving in the axial direction.

5. The fluid control valve according to claim 3, wherein
the valve element, the support member, the biasing member and the plunger are coaxially arranged.

6. The fluid control valve according to claim 2, wherein
the valve element is formed of an elastically deformable material,
the biasing member urges the valve element in the axial direction, and
the valve element and the biasing member are configured such that a displacement of the plunger in the axial direction due to deformation of the biasing member is larger than a displacement of the plunger due to deformation of the valve element during a valve closing process from contact between the valve element and a valve seat to a completion of valve closing through elastic deformation of the valve element without fluid pressure applied to the valve element.

7. The fluid control valve according to claim 1, wherein
the relief valve mechanism includes a relief passage through which the working fluid flows in the valve closed state, and an auxiliary valve that closes the relief passage, and
the auxiliary valve is pushed and opens the relief passage by the fluid pressure and allows the working fluid to flow through the fluid passage when the fluid pressure exceeds the predetermined pressure in the valve closed state.

8. The fluid control valve according to claim 7, wherein
the auxiliary valve is elastically deformed by the fluid pressure to open the relief passage.

9. The fluid control valve according to claim 7, comprising
a support member having a valve support that supports the valve element on an upstream side of the valve support and supports the auxiliary valve downstream of the valve element, wherein
the plunger is in contact with the support member while moving in the axial direction, and
the relief passage extends through the valve element and the valve support.

10. The fluid control valve according to claim 9, wherein
the valve element, the support member, the auxiliary valve, and the plunger are positioned to overlap each other in a flow direction of the working fluid.

11. The fluid control valve according to claim 2, wherein
the plunger and a yoke have parallel portions facing and extending along each other in cross-section to form a magnetic path through which magnetic flux passes between the plunger and the yoke,
the fluid control valve further comprising a support member integrally supports the valve element and the biasing member such that the valve element is movable in the axial direction, wherein
in the valve closed state in which the valve element and a valve seat are in contact with each other, the parallel portion of the plunger is in contact with the parallel portion of the yoke or in vicinity of the parallel portion of the yoke so as to form the magnetic path, and the plunger is in contact with the support member in the axial direction.

12. The fluid control valve according to claim 7, wherein
the plunger and a yoke have parallel portions facing and extending along each other in cross-section to form a magnetic path through which magnetic flux passes between the plunger and the yoke,
the fluid control valve further comprising a support member having a valve support that supports the valve element on an upstream side of the valve support and supports the auxiliary valve downstream of the valve element, wherein
in the valve closed state in which the valve element and a valve seat are in contact with each other, the parallel portion of the plunger is in contact with the parallel portion of the yoke or in vicinity of the parallel portion of the yoke so as to form the magnetic path, and the plunger is in contact with the support member in the axial direction.

13. The fluid control valve according to claim 1, comprising:
a first path which is a magnetic path through which magnetic flux passes between the plunger and a yoke; and
a second path that is a magnetic path through which a magnetic flux passes between the plunger and the yoke in a portion different from the first path,
wherein
the first path and the second path are positioned such that the first path is larger in magnetic flux than the second path when energization is started in the valve open state, and the second path is larger in magnetic flux than the first path in the valve closed state.

14. The fluid control valve according to claim 1, wherein
the plunger and a yoke have parallel portions facing and extending along each other in cross-section to form a magnetic path through which magnetic flux passes between the plunger and the yoke, and
the valve closed state is provided such that the parallel portion of the plunger is brought into contact with the parallel portion of the yoke, and then the valve element comes into contact with a valve seat in a state where the fluid pressure does not act on the valve element in a valve opening direction.

15. A fluid control valve comprising:
a housing having a fluid passage through which a liquid working fluid flows;
a valve element provided inside the housing and configured to be switched between a valve open state in which the valve element is placed to open the fluid passage and a valve closed state in which the valve element is placed to close the fluid passage;
a plunger provided inside the housing and moved in an axial direction to displace the valve element;
a coil provided inside the housing and energized to generate a magnetic force that moves the plunger in the axial direction toward the valve closed state; and
a relief spring compressed to exert a biasing force in the valve closed state to bias the valve element in the axial direction to keep the valve closed state, the relief spring being further compressible without moving the plunger in the valve closed state, the biasing force being preset lower than a predetermined pressure such that the relief spring is further compressed to allow the working fluid to flow through the fluid passage without moving the plunger in the axial direction when a fluid pressure of the working fluid exceeds the predetermined pressure in the valve closed state.

16. A fluid control valve comprising:
a housing having a fluid passage through which a liquid working fluid flows;
a valve element provided inside the housing and configured to be switched between a valve open state in which the valve element is placed to open the fluid passage and a valve closed state in which the valve element is placed to close the fluid passage;
a plunger provided inside the housing and moved in an axial direction to displace the valve element;
a coil provided inside the housing and energized to generate a magnetic force that moves the plunger in the axial direction toward the valve closed state;
a relief passage through which the working fluid flows in the valve closed state; and
an auxiliary valve that opens or closes the relief passage in the valve closed state, wherein
the auxiliary valve is pushed and opens the relief passage by the fluid pressure and allows the working fluid to flow through the fluid passage when the fluid pressure exceeds the predetermined pressure in the valve closed state.
